(19) United States
(12) Patent Application Publication
(10) Pub. No.: US 2008/0201013 A1
(43) Pub. Date: Aug. 21, 2008

(54) Device for Contactless Detection of Filling Levels

(76) Inventor: Gerhard Schaefer, Neunkirchen (DE)

Correspondence Address: KEVIN J. MCNEELY, ESQ., 5335 WISCONSON AVENUE, NW, SUITE 440, WASHINGTON, DC, 20015, US

(21) Appl. No.: 12/025,301

(22) Filed: Feb. 4, 2008

(30) Foreign Application Priority Data
Aug. 3, 2005 (DE) DE102005036 434.9

(51) Int. Cl. G06F 17/00

(52) U.S. Cl. 700/244

(57) ABSTRACT

An apparatus for contactless detection of filling levels of automatic machine shafts, each including removal units of an order-picking system, wherein the removal units dispense piece goods on one or more conveyor units. A distance measuring device is provided which can travel along a guidance track to measurement positions associated with different automatic machine shafts. The guidance track is provided on the automatic machine shafts, and the distance measuring device has a reading unit which can be pivoted into a plane of each automatic machine shaft.

### RELATED APPLICATIONS

This is a continuation application of co-pending International Patent Application PCT/EP2006/065017 which claims priority of German application DE 10 2005 036 434.9 filed on Aug. 3, 2005 which is fully incorporated by reference herewith.

### BACKGROUND OF THE INVENTION

The invention relates to a device for contactless detection of filling levels of automatic machine shafts, being provided with removal units, of an order-picking system, wherein the removal units dispense piece goods on one or more conveyor units, wherein a distance measuring device is provided and can be moved along a guidance track to a measurement position associated with different automatic machine shafts, wherein the guidance track is provided on the automatic machine shafts, as well as to a corresponding method for contactless detection of filling levels in order-picking systems.

Such automatic machine shafts are used with order-picking systems in different adaptations in order to deliver piece goods to one or more conveyor units through removal units arranged in the lower end region of the automatic machine shafts. The piece goods can comprise goods of any type which most times are provided in regular packages. The application field of such order-picking systems mainly is to be seen in the area of pharmaceutical trade, cosmetics, tobacco or food companies, distribution of audio and video and other distribution centers. Mostly, predetermined batches of piece goods are conveyed by the conveyor units, in correspondence to type and number, to transport containers where the shipping or the storing in a depot occurs.

### RELATED PRIOR ART

As a rule, the automatic machine shafts are arranged in one line side-by-side, wherein respectively two automatic machine shaft lines form a unit. Among other things, automatic machine shaft lines arranged in A-shape as well as automatic machine shafts arranged in V-shape are known.

In order to order-pick the batches of piece goods in accordance with an order and in the correct composition, and in order to prevent delays due to empty automatic machine shafts, reliable monitoring of the filling levels of respective piece goods in the automatic machine shafts is necessary. Unnoticed emptying of automatic machine shafts can cause all kinds of complications with respect to quality assurance, and causes increased efforts with respect to shipping, stock keeping and complaints. Particularly in the pharmaceutical field, lacking of an active compound within a composition of medicaments is completely unwanted.

Such checking of filling level can also be used for permanent inventory monitoring or inventory of an order-picking system.

Typically, automatic machine shafts of order-picking systems according to the prior art are provided with detection of an emptying of an automatic machine shaft, and in such cases cause notification with respect to an “empty state”. Since malfunction in the delivery of piece goods has to be avoided during the order-picking process due to the mentioned complications, intensive visual checking of the filling level of the automatic machine shafts is required, and requires the permanent monitoring of the order-picking system by corresponding personnel.

Thus, one drawback of such devices is to be seen in that an approaching lack of piece goods in one of the automatic machine shafts often is not reliably registered in due time, so that measures for filling that automatic machine shaft can only be taken belated, and a number of batches of piece goods being already conveyed towards shipping through the conveyor unit can have a deficit with respect to specific goods.

Therefore, WO 2005/087625 A1 teaches a device for contactless detection of filling levels of automatic machine shaft lines being provided with removal units and being arranged obliquely with an A-shape relative to a conveyor unit, wherein a movable carrier including a distance measuring device is provided which is movable along a guidance track to measurement positions associated with different automatic machine shafts. For allowing detection of the filling level of both automatic machine shaft lines, however, at least two distance measuring devices are required with that device, one for each line of the automatic machine shafts.

Therefore, it is an object of the present invention to prevent such drawbacks, and to provide a device and a method for contactless detection of filling levels of automatic machine shafts in order-picking systems by which an optimal check of filling levels of all kinds of automatic machine shafts being arranged in the order-picking system and used is ensured, wherein initiating emptying of one automatic machine shaft is signalled in due time to the system user in terms of a warning message according to the purpose.

It is another object of the invention to provide a device for contactless detection of filling levels which is simple to assemble and nevertheless allows contactless filling level detection, when using as little as possible distance measuring devices having high acquisition costs.

Particularly, a device is to be provided which can be easily and manufacturer-independently retrofitted at existing order-picking systems, and which realises greatest possible check coverage of the filling level of the automatic machine shafts when using a minimum of movable units.

### SUMMARY OF THE INVENTION

This object is achieved by a device having a distance measuring device having a reading unit which can be pivotated into a plane of each automatic machine shaft. The distance measuring device preferably operates optically or by means of supersonic, however, it can also operate with other contactless techniques, if necessary.

The distance measuring device is arbitrarily movable along a guidance track, and can be moved to different measurement positions being associated with individual automatic machine shafts. The determined measurement values can be forwarded to an external computing unit over analogue or digital interfaces for evaluation purposes.

In this manner, the accurate filling levels in order-picking systems can be monitored efficiently. Failures, interruptions or even breakdowns of the order-picking system due to an emptying of an automatic machine shaft which is recognized too late, can thus be prevented effectively. Provision of a separate guidance track for the distance measuring device allows a simple and manufacturer-independent retrofitting of such a device in conventional order-picking systems. Due to a dedicated displacement measuring system the device is independent of any automatic machine shaft configuration, and can be used without any interface to the automatic machine shaft.

The capability to be pivoted, in accordance with the invention, guarantees that an accurate orientation of the measuring beam of the distance measuring device is possible in each automatic machine shaft, independently of the inclination thereof.

An embodiment of the device in accordance with the invention of an order-picking system has automatic machine shafts which are arranged in automatic machine shaft lines being oblique relative to a conveyor unit, in order to deliver the conveyor unit with piece goods, wherein the guidance track for the distance measuring device is arranged in a region of an imaginary intersection line formed by planes of the automatic machine shaft lines.

In accordance with the invention, the capability to pivot the reading unit of the distance measuring device allows checking of two automatic machine shaft lines with only one distance measuring device. The arrangement of the guidance track in the region of the imaginary intersection line allows an optimal opportunity to detect the filling levels.

With an embodiment of the device according to the present invention of an order-picking system, the automatic machine shafts are arranged in automatic machine shaft lines, wherein the guidance track comprises a closed loop-like course, so that continuous movement of the distance measuring device along the guidance track is possible. In this manner, the filling level of several automatic machine shafts, being arranged one after the other, and automatic machine shaft lines, respectively, can be detected correspondingly. Particularly, the filling level of both A-shaped arranged automatic machine shaft lines and V-shaped arranged automatic machine shaft lines can be detected without problems due to the closed loop-like course of the guidance track, wherein the direction of movement of the distance measuring device does not need to be inverted.

Further, the distance measuring device can also comprise a device for optically deflecting emitted measuring beams, preferably a mirror, thereby also detecting the filling level of automatic machine shafts into which the measuring beam of the distance measuring device cannot be directed, for example, due to the specific orientation of the automatic machine shafts, by the pivotability of the reading unit alone, or, in other words, this specific feature extends the detection range of the distance measuring device.

Moreover, the distance measuring device is kept movable in an endless manner along a track section assigned thereto on the guidance track, preferably from a first end position to a second end position. The determined track section, of course, can include the entire length of the guidance track, however, in practice it is possible that for specific order-picking configurations, filling level checks are to be performed merely for specific automatic machine shafts or automatic machine shaft groups, and thus positioning of the distance measuring device is only required at selected measuring positions. Hence, optimizations with respect to the conveyor technique are possible.

Further, a computer connected to the distance measuring device is provided, the computer allowing association of received measuring data with position data of the distance measuring device. By accurately registering the position of the distance measuring device at any time by means of a displacement measuring system, the determined filling level can be assigned accurately to the position of a defined automatic machine shaft, and can be depicted subsequently by an output device numerically or graphically. That computer can also be integrated into the removal units.

Even further, at least one sensor on the distance measuring device is provided, detecting the walls of the individual automatic machine shaft during movement of the distance measuring device. In one preferred embodiment, the upper edge of a wall separating two automatic machine shafts from each other is detected by means of a light beam, however the wall can also be detected by means of a contact sensor. In this manner, the accurate width of a shaft, and, hence, the next measurement position, can be determined accurately for the distance measurement device.

A method is disclosed for contactless detection of filling levels of automatic machine shafts having removal units in order-picking systems by means of a distance measuring device, particularly an optoelectronic distance measuring device. At the same time, a distance measuring device is positioned along a guidance track on an automatic machine shaft, in order to perform a detection of the filling level of a respective automatic machine shaft at a defined measurement position. Accordingly, before the detection, orientation of the distance measuring device into the respective automatic machine shaft is performed, so that a configuration of the optics, or the reading unit, of the distance measuring device accurately corresponds to the inclination of the automatic machine shaft. In this manner, a measuring beam of the distance measuring device can accurately impinge in a normal plane onto the piece goods filled into the automatic machine shaft, wherein differently inclined automatic machine shafts can also be detected accurately due to the capability of the reading unit of the distance measuring device according to the present invention to be pivoted. Subsequently, the data received with respect to the filling level are associated with the position data of the distance measuring device being provided by a displacement measuring system. Preferably, the distance measuring device subsequently is positioned and orientated at another automatic machine shaft, and the measuring process including the position data association is repeated. In this manner, the current filling level of an arbitrary automatic machine shaft of the order-picking system can be observed, in order to take appropriate measures for manually or automatically refilling the same if emptying thereof approaches. Also, permanent checking of the dispensing process is thus possible.

Further, it is possible that the distance measuring device is returned at the end of a track section assigned thereto on the guidance track opposite to its previous movement direction along the previously traveled track section. Then, the measuring data obtained at the automatic machine shaft path are updated by performing the measuring process in an inverse order again, thereby allowing the distance measuring device to be permanently active in its measuring operation without the need for the measuring device to return to a start position before a new measurement process. Preferably, the distance measuring device and, respectively, a measuring beam emitted therefrom is orientated, after the above-mentioned change of movement direction, into another one of the automatic machine shaft lines formed by automatic machine shafts instead of the automatic machine shaft line previously checked. The distance measuring device can be returned, in case of provision of a loop-like guidance track which has several automatic machine shaft lines assigned thereto, along another automatic machine shaft line, and continue its circulation on the guidance track in an endless cycle.

Also, the process of driving off the track section of the guidance track including a subsequent updating of the measuring data can be repeated continuously or in arbitrary intervals. In this manner, the order-picking cycle of the system and the filling level of all kinds of operative automatic machine shafts can be monitored permanently.

Preferably, the detected data are forwarded to a central microprocessor where the data particularly are evaluated according to adjustable parameters, and subsequently can be depicted on a central monitor. Thus, the associated data can be adequately discarded in a production process, in order to allow a reaction to an approaching emptying of piece goods in one of the automatic machine shafts in due time.

The distance measuring device might move along defined track sections of the guidance track in alternating movement directions allowing guidance of the distance measuring device along arbitrarily defined track sections into which the guidance track is subdivided. The movement direction of the measuring device can be changed variably during the movement cycle. In this manner, diverse order-picking configurations are allowable since in this manner, for example, only automatic machine shafts being operative for a picking order or being relevant can be monitored without the need to travel the entire guidance track. Also, check priority can be programmed for specific automatic machine shafts or automatic machine shaft groups, so that filling level detection at the measuring positions associated therewith occurs with increased frequency in comparison to other automatic machine shafts.

In case of piece goods having unknown dimensions, or if the piece good is located disordered within the automatic machine shaft, it is possible to determine a difference of the filling level in the automatic machine shaft, while a dispense process of piece goods is carried out at the removal unit. At the same time, the distance measuring device determines two distance values during the time period in which piece goods are dispensed on the conveyor unit, i.e. a filling level of the automatic machine shaft prior the dispensing of piece goods by the removal unit, and another filling level of the same automatic machine shaft after the dispensing of piece goods. On the basis of the difference of the filling level, determined by usage of the two distant values, the piece good size, and thus the stock of piece goods in a respective automatic machine shaft, can then be calculated.

For allowing an accurate determination of the next measurement position during the positioning of the distance measuring device, the walls separating the individual automatic machine shafts from each other are detected by a sensor during the passing of the distance measuring device. In that manner, the accurate width of an automatic machine shaft can be calculated, and the distance measuring device can be re-adjusted with respect to its optimal measuring position.

### BRIEF DESCRIPTION OF THE DRAWINGS

The invention is now explained in more detail on the basis of an exemplary embodiment, wherein:

FIG. 1 is a perspective representation of an order-picking system including a filling level detection device in accordance with the invention;

FIG. 2 is a side view of the order-picking system of claim 1;

FIG. 3 is a schematic representation of an order-picking system having a filling level detection device in accordance with the invention at automatic machine shaft lines being inclined relative to each other;

FIG. 4 is a schematic side view of two order-picking systems of claim 3 being arranged side by side; and

FIG. 5 is a top view of the schematic view of FIG. 4.

### DESCRIPTION OF PREFERRED EMBODIMENTS

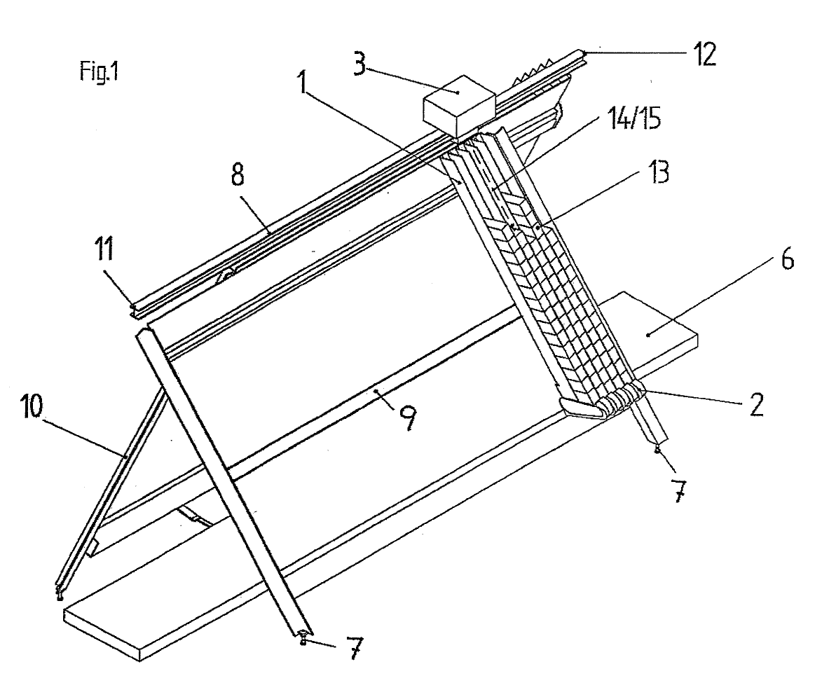

In FIGS. 1, 2 and 3, order-picking systems are depicted as being used in different application fields for commissioning selected batches of piece goods. The order-picking system includes, in a simple embodiment, a base frame 10 onto which, independent of the constructional system, a number of automatic machine shafts 1 can be arranged. In the automatic machine shafts 1, diverse piece goods 13 are stored which are to be dispensed in selected composition and number onto one or more conveyor units 6 from where the transport to further shipping or storing then occurs.

The automatic machine shaft 1 has an upper end region 1a and a lower end region 1b including a removal unit 2 for automatically feeding the conveyor unit 6, arranged beneath the automatic machine shaft 1, with piece goods 13. The base frame 10 comprises several shelf braces 9 serving for an additional support of the automatic machine shafts 1, and is provided with main pillars 7.

In FIGS. 1, 2 and 3, indeed the typical way of arranging automatic machine shafts 1 in practice in an order-picking system is depicted, i.e. automatic machine shaft lines 4 and 5 are arranged obliquely in A-shape or arranged obliquely relative to the conveyor unit 6 in V-shape, but it is also possible to arrange an individual automatic machine shaft 4 in a vertical position or in a position being arbitrarily inclined relative to the conveyor unit 6. For specific requirements, it is also possible to arrange several automatic machine shaft lines in planes being parallel to each other dispensing piece goods 13 common onto one or even more conveyor units 6.

A guidance track 8 is provided on the automatic machine shaft 1 along which a distance measuring device 3 is guided. The guidance track 8 can be an integral part of the order-picking system, but preferably is implemented as a separate path being independent of the order-picking system, in order to allow manufacturer-independent retrofitting of a device in accordance with the invention in commercially available order-picking systems.

The distance measuring device 3 can travel to measurement positions, associated with different automatic machine shafts 1, along the guidance track 8, and comprises in accordance with the invention a reading unit which can be pivoted into a plane of the automatic machine shafts 1. In one preferred embodiment of the invention, the distance measuring device operates by means of optical scanning, or supersonic, wherein distances, for example, in accordance with the principle of pulsed light travel time measurements, can be determined within the automatic machine shafts 1 fast and in the order of millimetres accurately. The arrows 14 and 15 designate the directions of the measuring beams emitted by the distance measuring device 3.

The guidance track 8 can be divided into defined track sections, and comprises preferably a first end position 11 and a second end position 12 between which the translational movement of the distance measuring device 3 occurs. In the regular case, the predetermined track section includes the entire length of the guidance track 8, in case of specific order-picking configurations the positioning of the distance measuring device 3, however, might only be required at selected automatic machine shaft groups and, thus, at a restricted number of measurement positions, and the track section definition can be adapted correspondingly.

The device according to the invention is independent of any automatic machine shaft configuration due to its own displacement measuring system. Since it does not have an interface to the automatic machine shaft 1, but operates in a superordinated manner, it can flexibly be adapted to order-picking systems of all kind, independent of its manufacturer.

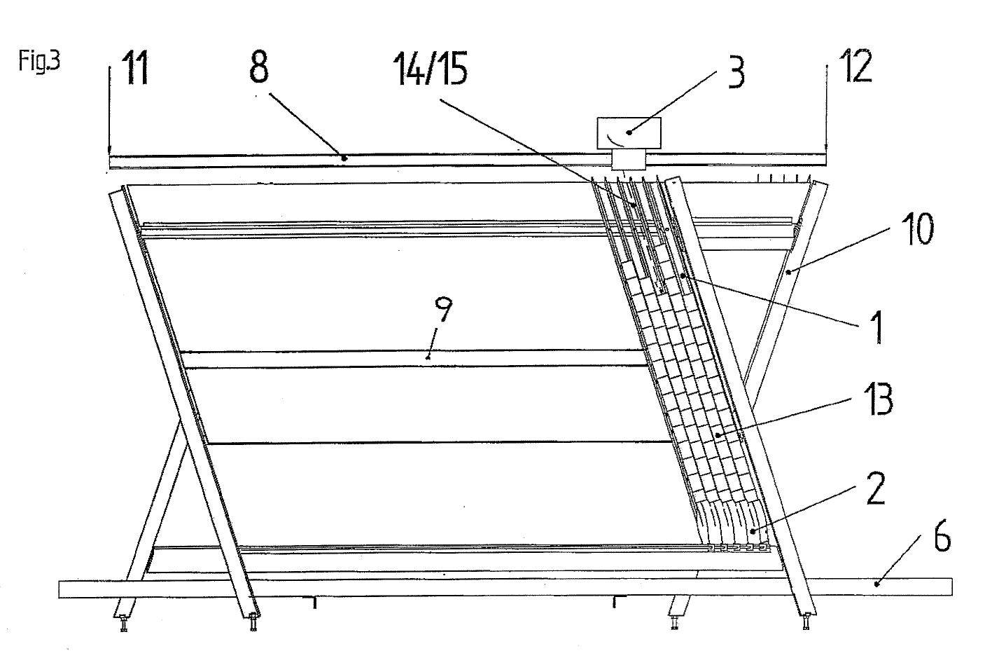

With one preferred embodiment, the guidance track 8 has a linear course, wherein the distance measuring device 3 travels up and down along that course continuously from a first end position 11 to a second end position 12, however, the guidance track 8 can comprise, if necessary, and specifically in the application case of an arrangement of two V-shaped automatic machine shaft lines 4, 5 converging towards one single conveyor unit 6 as depicted in FIG. 3, also a loop-like course or loop-like track section connecting linear track sections with each other. The latter embodiment having a circular loop-like course of the guidance track 8 allows also to check both automatic machine shaft lines 4, 5 by means of only one distance measuring device 3, as disclosed with respect to the embodiment in FIG. 3. Of course it is, however, also possible with such an arrangement to provide two separate guidance tracks 8 being arranged on the respective automatic machine shaft lines 4, 5 together with distance measuring devices 3.

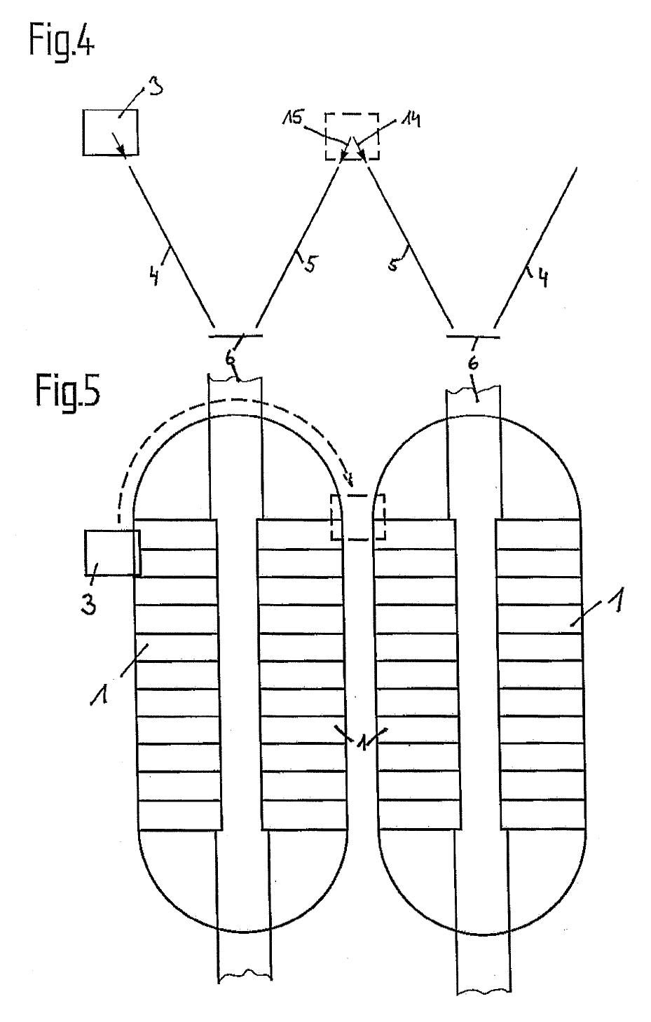

FIGS. 4 and 5 show several V-shaped automatic machine shaft lines 4, 5 arranged side by side and converging at a conveyor unit 6 being disposed therebetween, as illustrated in FIG. 3. Due to the specific arrangement, it follows that, inspite of the V-shaped arrangement of the automatic machine shaft lines 4, 5 of a unit, two adjacent automatic machine shaft lines 5 of units respectively being adjacent to each other, have an imaginary intersection line, and, therefore, one can detect both automatic machine shaft lines 5 with one single distance measuring device having a pivotable reading unit in accordance with the invention.

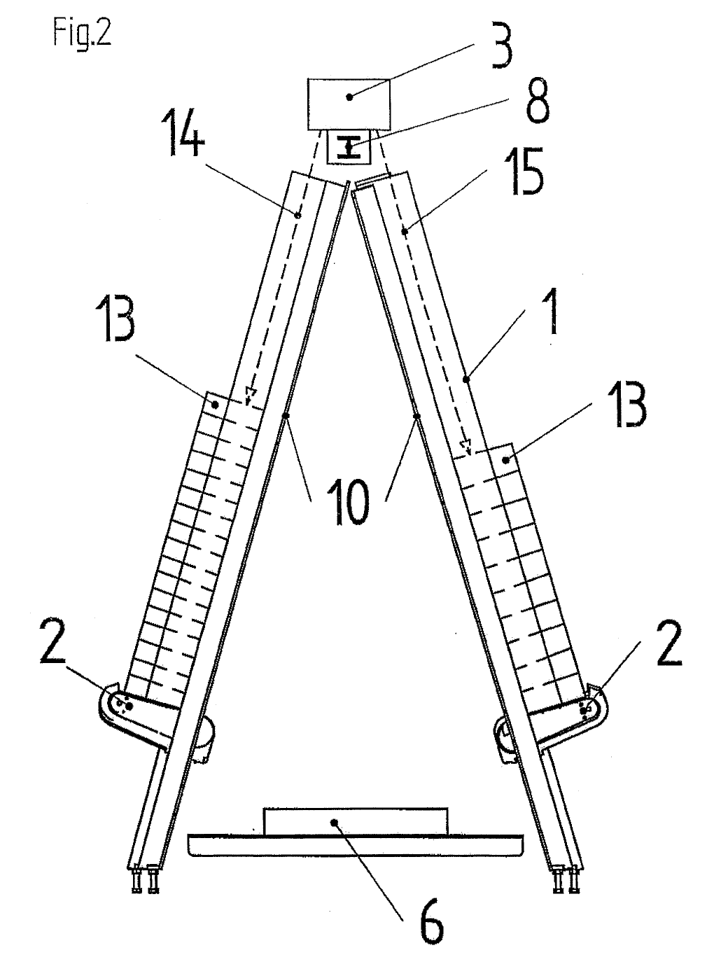

With the embodiment depicted in FIGS. 1 and 2, two automatic machine shaft lines 1 are arranged inclined with an A-shape to each other for feeding one or more conveyor units 6. In such an arrangement, the guidance track 8 is arranged for the distance measuring device 3 in a region of an imaginary intersection line formed by planes of the automatic machine shaft lines 4, 5.

Therein, the arrow 14 depicts the measuring beam of the distance measuring device 3 during a first travel along the guidance track 8, and the arrow 15 represents the measuring beam during a subsequent return travel opposite to the previous movement direction.

The pivotable reading unit in accordance with the invention allows also the accurate orientation of the measuring beam into the respective automatic machine shafts.

The combination of the pivotable reading unit of the present invention with a device for optically deflecting emitted measuring beams can serve for extending the detection range of the distance measuring device. At the same time, mirrors or other reflective partially transparent media can be employed which can be driven into a desired position by means of an actuating drive.

The drive of the distance measuring device 3 can be controlled arbitrarily in any case. In accordance with the invention, an interruption-free continuous and steady movement circulation of the distance measuring device 3 on the guidance track 8 is provided, so that the control function is performed almost in an endless loop, but the observation of a concrete process detail during the order-picking process can necessitate that the distance measuring device 3 stops its translational movement for a certain period of time at a measurement position, or is driven in a movement direction on the guidance track 8 in either an arbitrarily, currently controlled or programmed manner.

In operation, the distance measuring device 3 is positioned on the guidance track 8 at an automatic machine shaft 1, in order to carry out a detection of the filling level of a respective automatic machine shaft 1 at a defined measurement position. Subsequently, the obtained data relating to the filling level are associated with the position data of the distance measuring device 3 which, for example, are provided by the displacement measuring system. Then, the distance measuring device 3 is positioned at another automatic machine shaft 1, and the measuring device including the position data association is repeated.

Preferably, the distance measuring device, or a measuring beam emitted therefrom, is orientated into another automatic machine shaft line 4, 5, after having traveled an automatic machine shaft line 4, 5, and updating of the filling levels of the opposite automatic machine shaft line 4, 5 is performed.

The determined measurement values can be forwarded via analogue or digital standard interfaces to an external computing unit where they are evaluated in order to monitor the filling levels of the individual automatic machine shafts 1 of the order-picking system efficiently. By accurately registering the position of the distance measuring device 3 at any time by means of the displacement measuring system, the determined filling level can be accurately assigned to the position of a defined automatic machine shaft 1. The measuring data obtained with respect to the filling level of a defined automatic machine shaft 1 are associated, by the aid of the computer, with the position data of the distance measuring device 3, and then illustrated, pre-processed by an output device, preferably on a central monitor in accordance with parameters adjusted corresponding to the production process.

The current filling level of the automatic machine shafts 1 also can be tracked accurately on the display at any time. If piece goods run short in an automatic machine shaft 1, a corresponding warning message in terms of an optical or acoustic signal can be set. The filling level state specific for each of the automatic machine shafts 1 or for a specific type of piece goods, for which a warning message is initiated, can be set variably by parameters.

In accordance with the invention, at least one sensor is arranged at the distance measuring device 3, the sensor detecting the walls of the individual automatic machine shafts 1 during the travel of the distance measuring device 3. In a preferred embodiment, the upper edge of a wall separating two automatic machine shafts 1 from each other is detected by means of a light beam, but the wall can also be detected by means of a contact sensor. In this manner, the accurate width of a shaft, and thus the next measuring position for the distance measuring device 3, can be determined accurately.

Although mainly regularly packed and stored goods are order-picked onto the conveyor unit 6 in accordance with the described order-picking system, also disordered filling of piece goods 13 in the automatic machine shafts 1 is possible, for instance with round piece goods. In such an application case, the difference of the filling level in the automatic machine shaft 1 is determined while piece goods are dispensed at the removal unit 2. The distance measuring device 3 determines during the dispense of piece goods onto the conveyor unit 6 two distance values, mainly a filling state of the automatic machine shaft 1 before the piece good is dispensed by means of the removal unit 2, and another filling level of the same automatic machine shaft after the dispensing of piece goods. The resulting difference of the filling level finally allows computational evaluation, by a computer, of the piece good size, and thus the stock of piece goods 13 in a respective automatic machine shaft 1.

The device in accordance with the invention is adapted for greatest possible efficiency with simultaneous economical component configuration, and intends, as described with respect to the above-mentioned embodiment, to achieve check coverage of all automatic machine shafts 1 with only one single distance measuring device 3, if possible. However, due to the respective constructional constraints and for the purpose of an increase of the checking and updating frequency, as well as safety measures, it can make sense to provide, in the case of a defect of the distance measuring device 3, and a delay within the order-picking process caused thereby, which can in most cases not be accepted, further distance measuring devices 3 on the guidance track 8, or to equip one distance measuring device 3 with multiple reading units.

1. An apparatus for contactless detection of filling levels of automatic machine shafts, each comprising removal units of an order-picking system, wherein the removal units dispense piece goods on one or more conveyor units, wherein a distance measuring device is provided which can travel along a guidance track to measurement positions associated with different automatic machine shafts, the guidance track being provided on the automatic machine shafts, and the distance measuring device having a reading unit which can be pivoted into a plane of each automatic machine shaft.

2. The apparatus of claim 1, wherein the distance measuring device operates by means of optical scanning or supersonic.

3. The apparatus of claims 1, wherein the automatic machine shafts are arranged in automatic machine shaft lines obliquely inclined relative to the conveyor unit, the guidance track for the distance measuring device being arranged in a region of an imaginary intersection line formed by planes of the automatic machine shaft line.

4. The apparatus of claim 1, wherein the automatic machine shafts are arranged in automatic machine shaft lines, the guidance track for the distance measuring device running along an upper end region of the automatic machine shaft lines, wherein the guidance track comprises a closed loop-like course so that of the distance measuring device continuously moves on the guidance track.

5. The apparatus of claim 1, wherein the distance measuring device has a device for optically deflecting emitted measuring beams.

6. The apparatus of claim 5, wherein the device for optically deflecting is a mirror.

7. The apparatus of claim 1, wherein the distance measuring device is kept endlessly movable along a track section assigned thereto on the guidance track.

8. The apparatus of claim 7, wherein the distance measuring device moves from a first end position to a second end position.

9. The apparatus of claim 1, wherein a computer is provided which is connected to the distance measuring device and serves for associating received measurement data with position data of the distance measuring device.

10. The apparatus of claim 1, wherein at least one sensor is provided at the distance measuring device, the sensor detecting walls while the distance measuring device travels, the walls separating individual automatic machine shafts from each other.

11. A method for contactless detecting filling levels of automatic machine shafts having removal units of an order-picking systems by means of a distance measuring device, comprising the following steps:
positioning the distance measuring device at a measuring position along a guidance track being provided on an automatic machine shaft;
orientating the distance measuring device into the automatic machine shaft;
performing detection of the filling level of the automatic machine shaft;
associating the obtained data with the position data of the distance measuring device; and
positioning the distance measuring device at another automatic machine shaft, and repeating the previous steps.

12. The method of claim 11, wherein the distance measuring device is returned at the end of a track section assigned thereto on the guidance track opposite to its previous movement direction along the track section traveled before, and updating the measuring data obtained at the automatic machine shafts traveled by performing the measuring process in inverted order again.

13. The method of claim 12, wherein the process of travelling the track section of the guidance track with subsequently updating the measuring data is repeated continuously or in arbitrary intervals.

14. The method of claim 11, wherein the detected data are forwarded to a central microprocessor.

15. The method of claim 14, wherein the detected data are evaluated in accordance with adjustable parameters, and depicted on a central monitor.

16. The method of claim 11, wherein the distance measuring device moves along defined track sections of the guidance track in alternating movement directions.

17. The method of claim 16, wherein a difference of the filling level in the automatic machine shaft, in case of piece goods arranged disordered in the automatic machine shafts, is determined by means of the distance measuring device during the performance of dispensing piece goods at the removal unit.

18. The method of claim 17, wherein the piece goods size, and thus the stock of the piece goods in the respective automatic machine shaft, is calculated based on the determined difference of the filling level in the automatic machine shaft during the dispense process of piece goods by means of a calculating unit.

19. The method of claim 11, wherein the walls separating the individual automatic machine shafts from each other are detected by a sensor, during the passing of the distance measuring device for allowing accurate determination of the next measuring position.

20. The method of claim 11, wherein the distance measuring device is optoelectronic.
